(19) United States
(12) Patent Application Publication
(10) Pub. No.: US 2004/0247157 A1
(43) Pub. Date: Dec. 9, 2004

(54) Method for preparing image information

(76) Inventors: Ulrich Lages, Hamburg (DE); Klaus Dietmayer, Ulm (DE)

Correspondence Address: HARNESS, DICKEY & PIERCE, P.L.C., P.O. BOX 828, BLOOMFIELD HILLS, MI, 48303, US

(21) Appl. No.: 10/480,506

(22) PCT Filed: Jun. 14, 2002
(86) PCT No.: PCT/EP02/06599

(30) Foreign Application Priority Data
Jun. 15, 2001 (DE) 101 28 954.5
Jul. 4, 2001 (DE) 101 32 335.2

(51) Int. Cl. G06K 9/00

(52) U.S. Cl. 382/103; 382/104; 382/106; 382/154

(57) ABSTRACT

The invention relates to method for preparing image information relating to a monitoring region in the visual region of an optoelectronic sensor, especially a laser scanner, used to record the position of objects in at least one recording plane, and in the visual region of a video system having at least one video camera. Depth images recorded by the optoelectronic sensor respectively contain pixels corresponding to points of a plurality of recorded objects in the monitoring region, with position co-ordinates of the corresponding object points, and the video images recorded by the video system comprise the pixels and the data detected by the video system. On the basis of the recorded position co-ordinates of at least one of the object points, at least one pixel corresponding to the object point and recorded by the video system is defined. The data corresponding to the pixel of the video image and the pixel of the depth image and/or the position co-ordinates of the object points are associated with each other.

The present invention relates to a method for the provision of image information concerning a monitored zone.

Monitored zones are frequently monitored using apparatuses for image detection in order to recognize changes in these zones. Methods for the recognition and tracking of objects are in particular also used for this purpose in which objects are recognized and tracked on the basis of sequentially detected images of the monitored zone, said objects corresponding to objects in the monitored zone. An important application area of such methods is the monitoring of the region in front of a vehicle or of the total near zone around the vehicle.

Apparatuses for image detection are preferably used for the object recognition and object tracking with which depth resolved images can be detected. Such depth resolved images contain information on the position of detected objects relative to the image detecting apparatus and in particular on the spacing of at least points on the surface of such objects from the image detecting apparatus or on data from which this spacing can be derived.

Laser scanners can be used, for example, as image detecting apparatuses for the detection of depth resolved images and scan a field of view in a scan with at least one pulsed radiation beam, which sweeps over a predetermined angular range, and detect radiation impulses, mostly diffusely reflected radiation impulses, of the radiation beam reflected by a point or by a region of an object. The run time of the transmitted, reflected and detected radiation impulses are detected in this process for the distance measurement. The raw data thus detected for an image point can then include the angle at which the reflection was detected and the distance of the object point determined from the run time of the radiation impulses. The radiation can in particular be visible or infrared light.

Such laser scanners admittedly provide very accurate positional information and in particular very accurate spacings between object points and lasers scanners, but these are as a rule only provided in the detection plane in which the radiation beam is moved so that it can be very difficult to classify a detected object solely on the basis of the positional information in this plane. For example, a traffic light, of which only the post bearing the lights is detected, can thus not easily be distinguished from a lamppost or from a tree, which has a trunk of the same diameter, in the detection plane. A further important example for the application would be the distinguishing between a person and a tree.

Depth resolved images can also be detected with video systems using stereo cameras. The accuracy of the depth information falls, however, as the spacing of the object from the stereo camera system increases, which make an object recognition and object tracking more difficult. Furthermore, the spacing between the cameras of the stereo camera system should be as high as possible with respect to an accuracy of the depth information which is as high as possible, which is problematic with limited installation space such as is in particular present in a vehicle.

It is therefore the object of the present invention to provide a method with which image information can be provided which permit a good object recognition and tracking.

The object is satisfied in accordance with a first alternative by a method having the features of claim 1.

In accordance with the invention, a method is provided for the provision of image information concerning a monitored zone which lies in the field of view of an optoelectronic sensor for the detection of the position of objects in at least one detection plane and in the field of view of a video system having at least one video camera, in which depth images are provided which are detected by the optoelectronic sensor and which each contain image points which correspond to object points on one or more detected objects in the monitored zone and have positional coordinates of the corresponding object points, and video images of a region which contain the object points and which include image points with data detected by the video system, in which at least one image point corresponding to the object point and detected by the video system is determined on the basis of the detected positional coordinates of at least one of the object points and in which data corresponding to the image point of the video image and the image point of the depth image and/or the positional coordinates of the object point are associated with one another.

In the method in accordance with the invention, the images of two apparatuses for image detection are used whose fields of view each include the monitored zone which can in particular also correspond to one of the two fields of view. The field of view of a video system is as a rule three-dimensional, but that of an optoelectronic sensor for positional recognition, for example of a laser scanner, only two-dimensional. The wording that the monitored zone lies in the field of view of a sensor, is therefore understood in the case of a two-dimensional field of view such that the projection of the monitored zone onto the detection zone in which the optoelectronic sensor detects positional information lies within the field of view of the optoelectronic sensor.

The one apparatus for image detection is at least one optoelectronic sensor for the detection of the position of objects in at least one detection plane, i.e. for the detection of depth resolved images which directly or indirectly contain data on spacings of object points from the sensor in the direction of the electromagnetic radiation received by the sensor and coming from the respective object points. Such depth resolved images of the optoelectronic sensor are termed depth images in this application.

Optoelectronic sensors for the detection of such depth resolved images are generally known. For example, systems with stereo cameras can thus be used which have a device for the conversion of the intensity images taken by the cameras into depth resolved images. However, laser scanners are preferably used which permit a very precise positional determination. They can particularly be the initially named laser scanners.

A video system is used as the second apparatus for image detection and has at least one video camera which can, for example, be a row of photo-detection elements or, preferably, cameras with CCD or CMOS area sensors. The video cameras can operate in the visible range or in the infrared range of the electromagnetic spectrum in this process. The video system can have at least one monocular video camera or also a stereo camera or a stereo camera arrangement. The video system detects video images of a field of view which can contain image points with, for example, intensity information and/or color information. The photo-detection elements of a camera arranged in a row, in a column or on a surface can be fixedly arranged with respect to the optoelectronic sensor for the detection of depth images or—when laser scanners of the aforesaid kind are used—can preferably also be moved synchronously with the radiation beam and/or with at least one photo-detection element of the laser scanner which detects reflected or remitted radiation of the radiation beam.

In accordance with the invention, initially depth images are provided which are detected by the optoelectronic sensor and which each contain image points corresponding to object points on one or more detected objects in the monitored zone and having positional coordinates of the corresponding object points, and video images of a zone containing the object points which are detected by the video system and which include image points with data detected by the video system. The provision can take place by direct transmission of the images from the sensor or from the video system or by reading out of a memory means in which corresponding data are stored. It is only important for the images that both can be a map of the same region which can generally be smaller than the monitored zone such that image points corresponding to the object point can appear both in the depth image and in the video image.

At least one image point corresponding to the object point and detected by the video system is then determined on the basis of the detected positional coordinates of at least one of the object points. As a result, an image point is determined in the video image which corresponds to an image point of the depth image.

Thereupon, data corresponding to the image point of the video image are associated with the image point of the depth image and/or the image point and the positional coordinates are associated with the positional coordinates of the object point or with the data, whereby a mutual complementation of the image information takes place. Video data of the video image are therefore associated with positional data of the depth image and these can be any desired data resulting directly or by an intermediate evaluation from the image points of the video image. The data can have intensity information or color information, for example, in dependence on the design of the video system and, if infrared cameras are used, also temperature information.

Data obtained in this manner for an object point can, for example, be output as new image points with data elements for positional coordinates and intensity information or color information, can be stored or can be used directly in a process running in parallel, for example for object recognition and object tracking.

Data can be provided by the method in accordance with the invention for an object point not only with respect either to the position or to other further optical properties of object points, for example, as is the case with simple sensors and video cameras, but also with respect to both the position and to the further properties. For example, the intensity and/or color for an object point can be provided in addition to the position.

The larger number of data associated with an image point permits not only the positional information to be used in object recognition and object tracking methods, but also video information. This can, for example, be very advantageous in a segmentation, in a segment to virtual object association or in the classification of virtual objects, since the larger number pieces of information or of data permits a more reliable identification.

The determination of an image point corresponding to an object point in the depth image in the video image can take place in a variety of ways. The relative position of the optoelectronic sensor to the video camera or to the video system, that is the spacing in space and the relative orientation, is preferably known for this purpose. The determination of the relative position can take place by calibration, for example. A further preferable design is the combination of the video system and of the laser scanner in one device, whereby the calibration can take place once in the manufacturing process.

If, for example, a video system which provides depth resolved images is used with a stereo camera, the determination can take place solely by a comparison of the positional information. In particular when video systems are used which do not provide any depth resolved images, however, the image point of the video image corresponding to the object point of a depth image is preferably determined in dependence on the imaging properties of the video system. In this application, the imaging properties are in particular also understood as the focal lengths of imaging apparatuses of the video camera or of the video system as well as their spacing from reception elements such as CCD or CMOS area sensors. If, for example, the video camera has an imaging apparatus such as a lens system which images the field of view onto a photo-detector field, e.g. a CCD or a CMOS area sensor, it can be calculated from the positional coordinates of an image point in the depth image, while observing the imaging properties of the imaging apparatus, on which of the photo-detector elements in the photo-detector field the object point corresponding to the image point is imaged, from which it results which image point of the video image the image point of the depth image corresponds to. Depending on the size of the photo-detector elements, on the resolution capability of the imaging apparatus and on the position of the object point, a plurality of image points of the video image can also be associated with one object point.

If the angles of view of the optoelectronic sensor and of the video system differ, the case can occur with a plurality of objects in the monitored zone that an object point visible in the depth image is fully or partly masked by another object point in the video image. It is therefore preferred that it is determined on the basis of the positional coordinates of an object point detected by the optoelectronic sensor in the depth image and at least on the basis of the position and orientation of the video system, whether the object point is fully or partly masked in the video image detected by the video system. For this purpose, the position of the video camera of the video system relative to the optoelectronic sensor should be known. This position can either be determined by the attachment of the optoelectronic sensor and of the video system in a precise relative position and relative orientation or can in particular also be determined by calibration.

It is furthermore preferred for the determination of image points of the video image corresponding to object points and for the association of corresponding data to the image points corresponding to the object points of the depth image for object points to take place in a pre-determined fusion region. The fusion region can initially be any desired region in the monitored zone which can be pre-determined, for example, in dependence on the use of the data to be provided. Independently of the monitored zone, in particular a smaller region lying inside the monitored zone can thus be pre-determined in which the complementation of data should take place. The fusion region then corresponds to a region of interest. The method can be considerably accelerated by the pre-determination of such fusion regions.

In a preferred embodiment of the method, the depth image and the video image are each first segmented. At least one segment of the video image which contains image points which correspond to at least some of the image points of the segment of the depth image is then associated with at least one segment in the depth image. The segmentation of the depth image and the segmentation of the video image, for example in video systems which detect depth resolved images, can admittedly take place according to the same criteria, but the segmentation preferably takes place in the depth image using positional information, in particular neighborhood criteria, and the segmentation in the video images takes place in accordance with other criteria, for example criteria known in the image processing of video images, for example on the basis of intensities, colors, textures and/or edges of image regions. The corresponding data can be determined by pre-processing stages, for example by image data filtering. This association makes it possible to associate segments of the video image as data to image points in the depth image. Information in directions perpendicular to the detection plane of the depth image in which the scan takes place by the optoelectronic sensor can thus in particular also be obtained. This can, for example, be the extension of the segment or of a virtual object associated with this segment in a third dimension. A classification of virtual objects in an object recognition and object tracking method can be made much easier with reference to such information. For example, a single roadside post on a road can easily be distinguished from a lamppost due to the height alone, although both objects do not differ or hardly differ in the depth image.

It is further preferred for the depth image to be segmented, for a predetermined pattern to be sought in a region of the video image which contains image points which correspond to image points of at least one segment in the depth image and for the result of the search to be associated as data to the segment and/or to the image points forming the segment. The pattern can generally be an image of a region of an object, for example an image of a traffic sign or an image of a road marking. The recognition of the pattern in the video image can take place with pattern recognition methods known from video image processing. This further development of the method is particularly advantageous when, on the basis of information on possible objects in the monitored zone, assumptions can already be made on what kind of objects or virtual objects representing said objects a segment in the depth image could correspond to. For example, on the occurrence of a segment which could correspond to the pole of a traffic sign, a section in the video image whose width is given by the size and by the position of the segment and the extent of the largest expected object, for example of a traffic sign, can be examined for the image of a specific traffic sign and a corresponding piece of information, for example the type of the traffic sign, can be associated with the segment.

With the help of an image evaluation of the video images for objects which were recognized by means of the optoelectronic sensor, their height, color and material properties can preferably be determined, for example. When a thermal camera is used as the video camera, a conclusion can also additionally be drawn on the temperature, which substantially facilitates the classification of a person.

The combination of information of the video image with those of the depth image can also serve for the recognition of objects or of specific regions on the objects which are only present in one of the images or can respectively support an interpretation of one of the images. For example, a video system can detect the white line of a lane boundary marking which cannot be detected using a scanner with a comparatively low depth resolution and angular resolution. However, a conclusion can also be made on the plausibility of the lane recognition from the video image from the movement of the other virtual objects and from the road curb detection.

The object underlying the invention is satisfied in accordance with a second alternative by a method in accordance with the invention having the features of claim 7.

In accordance with this, a method is provided for the provision of image information concerning a monitored zone which lies in the field of view of an optoelectronic sensor for the detection of the position of objects in at least one detection plane and in the field of view of a video system for the detection of depth resolved, three-dimensional video images using at least one video camera, in which depth images which are detected by the optoelectronic sensor and which each contain image points corresponding to object points on one or more detected objects in the monitored zone are provided and video images of a region containing the object points, which contain image points with positional coordinates of the object points are provided, said video images being detected by the video system, image points in the video image which are located close to or in the detection plane of the depth image are matched by a translation and/or rotation to corresponding image points of the depth image and the positional coordinates of these image points of the video image are corrected in accordance with the specific translation and/or rotation.

The statements with respect to the connection between the fields of view of the optoelectronic sensor and of the video system and the monitored zone in the method in accordance with the invention according to the first alternative also apply correspondingly to the method in accordance with the invention according to the second alternative.

The statements made with respect to the method in accordance with the invention according to the first alternative also apply to the method in accordance with the invention according to the second alternative with respect to the optoelectronic sensor and to the depth images detected by it.

The video system, which like the video system in the method in accordance with the first alternative, has at least one video camera to which the aforesaid statements also apply accordingly, is made in the method according to the second alternative for the detection of depth resolved, three-dimensional video images. The video system can for this purpose have a monocular camera and an evaluation unit with which positional data for image points are provided from sequentially detected video images using known methods. However, video systems with stereo video cameras are preferably used which are made in the aforesaid sense for the provision of depth resolved images and can have corresponding evaluation devices for the determination of the depth resolved images from the data detected by the video cameras. As already stated above, the video cameras can have CCD or CMOS area sensors and an imaging apparatus which maps the field of view of the video cameras onto the area sensors.

After the provision of the depth image and of the depth resolved video image, which can take place directly by transmission of current images or of corresponding data from the optoelectronic sensor or from the video system or by reading out corresponding data from a memory device, image points in the video image, which are located close to or in the detection plane of the depth image, are matched by a translation and/or rotation to corresponding image points of the depth image. For this purpose, at least the relative alignment of the optoelectronic sensor and of the video camera and their relative position, in particular the spacing of the video system from the detection plane in a direction perpendicular to the detection plane in which the depth image is detected by the optoelectronic sensor, termed the “height” in the following, should be known.

The matching can take place in a varied manner. In a first variant, the positional coordinates of all image points of a segment are projected onto the detection plane of the optoelectronic sensor. A position of the segment in the defection plane of the optoelectronic sensor is then defined by averaging of the image points thus projected. When, for example, suitable right angle coordinate systems are used in which one axis is aligned perpendicular to the detection plane, the method only means an averaging over the coordinates in the detection plane.

In a second, preferred variant, only those image points of the depth resolved video image are used for matching which lie in or close to the detection plane. Such image points are preferably considered as image points lying close to the detection plane which have a pre-determined maximum spacing from the detection plane. If the video image is segmented, the maximum spacing can, for example, be given by the spacing in a direction perpendicular to the detection plane of adjacent image points of a segment of the video image intersecting the detection plane. The matching can take place by optimization processes in which, for example, the—simple or quadratic—spacing of corresponding image points or the sum of the—simple or quadratic—spacings of all observed image points is minimized, with the minimization optionally only being able to take place in part depending on the available calculation time. “Spacing” is understood in this process as every function of the coordinates of the image points which satisfy criteria for a spacing of points in a vectorial space. On the matching, at least one translation and/or rotation is determined which is necessary to match the image points of the video image to those of the depth image.

The positional coordinates of these image points of the video image are thereupon corrected in accordance with the specific translation and/or rotation.

Image points of the video image lying in the direction perpendicular to the detection plane are preferably also accordingly corrected beyond the image points used in the matching.

All image points of the monitored zone, but also any desired smaller sets of image points can be used for the matching. In the first case, the matching corresponds to a calibration of the position of the depth image and of the video image.

The corrected coordinate data can then be output, stored or used in a method running in parallel, in particular as an image.

Since the positional information in the depth images is much more accurate, particularly when laser scanners are used, than the positional information in the direction of view with video systems, very accurate, depth resolved, three-dimensional images can thus be provided. The precise positional information of the depth image is combined with the accurate positional information of the video image in directions perpendicular thereto to form a very accurate three-dimensional image, which substantially facilitates an object recognition and object tracking based on these data.

Advertising hoardings with images can, for example, be recognized as surfaces such that a misinterpretation of the video image can be avoided.

Unlike the method in accordance with the invention according to the first alternative, in which the positional information is substantially supplemented by further data, in the method according to the second alternative, the accuracy of the positional information in a three-dimensional, depth resolved image is therefore increased, which substantially facilities an object recognition and object tracking.

Virtual objects can in particular be classified very easily on the basis of the three-dimensional information present.

In accordance with the invention, a combination is furthermore possible with the method according to the first alternative, according to which further video information are associated with the image points of the video image.

Although the method according to the second alternative can be carried out solely with image points, it is preferred for respectively detected images to be segmented, for at least one segment in the video image which has image points in or close to the plane of the depth image to be matched to a corresponding segment in the depth image at least by a translation and/or rotation and for the positional coordinates of these image points of the segment of the video image to be corrected in accordance with the translation and/or rotation. The positional coordinates of all image points of the segment are particularly preferably corrected. The segmentation can take place for both images on the basis of corresponding criteria, which as a rule means a segmentation according to spacing criteria between adjacent image points. However, different criteria can also be used for the depth image and for the video image; criteria known in the image processing of video images, for example a segmentation by intensity, color and/or edges, can in particular take place for the video image. By the correction of the positions of all image points of the segment, the latter is then brought into a more accurate position overall. The method according to this embodiment has the advantage that the same numbers of image points do not necessarily have to be present in the depth image and in the depth resolved video image or in sections thereof. On the matching, for which corresponding methods as in the matching of image points can be used, in particular the sums of the simple or quadratic spacings of all image points of the segment of the depth image of all image points of the segment of the video image in or close to the detection plane in the sense of the first or second variant can be used as the function to be minimized such that a simple, but accurate matching can be realized.

The method according to the second alternative can generally be carried out individually for each segment such that a local correction substantially takes place. It is, however, preferred for the matching to be carried out jointly for all segments of the depth image such that the depth image and the video image are brought into congruency in the best possible manner in total in the detection plane, which is equivalent to a calibration of the relative position and alignment of the optoelectronic sensor and of the video system.

In another embodiment, it is preferred for the matching only to be carried out for segments in a pre-determined fusion region which is a predetermined part region of the monitored zone and can be selected, for example, in dependence on the later use of the image information to be provided. The method can be substantially accelerated by this defined limitation to part of the monitored zone which is only of interest for a further processing (“region of interest”).

The following further developments relate to the method in accordance with the invention according to the first and second alternatives.

The methods in accordance with the invention can be carried out in conjunction with other methods, for example for the object recognition and object tracking. The image information, i.e. at least the positional information and the further data from the video image in the method in accordance with the first alternative and the corrected positional information in the method in accordance with the second alternative, are only formed as required. In these methods in accordance with the invention, it is, however, preferred for the provided image information to at least contain the positional coordinates of object points and to be used as the depth resolved image. The data thus provided can then be treated like a depth resolved image, i.e. be output or stored, for example.

If fusion regions are used in the methods, it is preferred for the fusion region to be determined on the basis of a pre-determined section of the video image and of the imaging properties of the video system. With this type of pre-determination of the fusion region, the depth image can be used, starting from a video image, for the purpose of gaining positional information for selected sections of the video image from the depth image which is needed for the evaluation of the video image. The identification of a virtual object in a video image is thus considerably facilitated, since a supposed virtual object frequently stands out from others solely on the basis of the depth information.

In another preferred further development, an object recognition and object tracking is carried out on the basis of the data of one of the depth resolved images or of the fused image information and the fusion region is determined with reference to data of the object recognition and object tracking. A supplementation of positional information from the depth image, which is used for an object recognition and object tracking, can thus in particular takes place by corresponding information from the video image. The fusion region can be given in this process by the extent of segments in the depth image or also by the size of a search region used in the object recognition for tracked objects. A classification of virtual objects or a segment/virtual object association can then take place with high reliability by the additional information from the video image. The presumed position of a virtual object in the video image can in particular be indicated by the optoelectronic sensor, without a classification already taking place. A vide image processing then only needs to search for virtual objects in the restricted fusion region, which substantially improves the speed and reliability of the search algorithms. I a later classification of virtual objects, both the geometrical measurements of the optoelectronic sensor, in particular of a laser scanner, and the visual properties, determined by the video image processing, can then be used, which likewise substantially improves the reliability of the statements obtained. A laser scanner can in particular, for example, detect road boundaries in the form of roadside posts or boundary posts, from which a conclusion can be drawn on the position of the road. This information can be used by the video system for the purpose of finding the white road boundary lines faster in the video image.

In another preferred further development, the fusion region is determined with reference to data on the presumed position of objects or of certain regions on the objects. The presumed position of objects can result in this process from information from other systems. In applications in the vehicle sector, the fusion region can preferably be determined with reference to data from a digital road map, optionally in conjunction with a global positioning system receiver. The course of the road can, for example, be predicted with great accuracy with reference to the digital map. This presumption can then be used to support the interpretation of the depth images and/or of the video images.

In a further preferred embodiment of the method in accordance with the invention, a plurality of depth images of one or more optoelectronic sensors are used which contain positional information of virtual objects in different detection planes. Laser scanners can particularly preferably be used for this purpose which receive transmitted electromagnetic radiation with a plurality of adjacent detectors which are not arranged parallel to the detection planes in which the scanning radiation beam moves. Very precise positional data in more than two dimensions, which in particular permit a better interpretation or correction of the video data in the methods in accordance with the invention are thereby in particular obtained on the use of depth images from laser scanners.

It is particularly preferred in this process for the matching for segments to take place simultaneously in at least two of the plurality of depth images in the method according to the second alternative. The matching for a plurality of depth images in one step permits a consistent correction of the positional information in the video image such that the positional data can also be corrected very precisely for inclined surfaces, in particular in a depth resolved image.

Specific types of optoelectronic sensors such as laser scanners detect depth images in that, on a scan of the field of view, the image points are detected sequentially. If the optoelectronic sensor moves relative to objects in the field of view, different object points of the same object appear displaced with respect to one another due to the movement of the object relative to the sensor. Furthermore, displacements relative to the video image of the video system can result, since the video images are detected practically instantaneously on the time scale at which scans of the field of view of a laser scanner take place (typically in the region of approximately 10 Hz).

If a depth image is used which was obtained in that the image points were detected sequentially on a scan of the field of view of the optoelectronic sensor, it is therefore preferred for the positional coordinates of the image points of the depth image each to be corrected prior to the determination of the image points in the video image or to the matching of the positional coordinates in accordance with the actual movement of the optoelectronic sensor, or a movement approximated thereto, and with i.a. the difference between the detection points in time of the respective image points of the depth image and a reference point in time. If a segmentation is carried out, the correction is preferably carried out before the segmentation. The movement of the sensor can, for example depending on the quality of the correction, be taken into account via its speed or also via its speed and its acceleration in this process, with vectorial values, that is values with amount and direction, being meant. The data on these kinematic values can be read in, for example. If the sensor is attached to a vehicle, the vehicle's own speed and the steering angle or the yaw rate can be used, for example, via corresponding vehicle sensors, to specify the movement of the sensor. For the calculation of the movement of the sensor from the kinematic data of a vehicle, its position on the vehicle can also be taken into account. The movement of the sensor or the kinematic data can, however, also be determined for a corresponding parallel object recognition and object tracking in the optoelectronic sensor or from a subsequent object recognition. Furthermore, a GPS position recognition system can be used, preferably with a digital map.

Kinematic data are preferably used which are detected close to the scan in time and particularly preferably during the scan by the sensor.

For the correction, the displacements caused by the movement within the time difference can preferably be calculated and the coordinates in the image points of the depth image correspondingly corrected from the kinematic data of the movement and from the time difference between the detection point in time of the respective image point of the depth image and a reference point in time using suitable kinematic formulae. Generally, however, modified kinematic relationships can also be used. It can be advantageous for the simpler calculation of the correction to initially subject the image points of the depth image to a transformation, in particular into a Cartesian coordinate system. Depending on the form in which the corrected image points of the depth image should be present, a back transformation can be meaningful after the correction.

An error in the positions of the images points of the depth image can also be caused in that two virtual objects, of which one was detected at the start of the scan and the other toward the end of the scan, move toward one another at high speed. This can result in the positions of the virtual objects being displaced with respect to one another due to the time latency between the detection points in time. In the case that depth images are used, which were obtained in that, on a scan of the field of view of the optoelectronic sensor, the image points were detected sequentially, a sequence of depth images is therefore preferably detected and an object recognition and/or object tracking is carried out on the basis of the image points of the images of the monitored zone, with image points being associated with each recognized object and movement data calculated in the object tracking being associated with each of these image points and the positional data of the image points of the depth image being corrected prior to the determination of the image points in the video image or prior to the segment formation using the results of the object recognition and/or object tracking. For the tracking of the positional information, an object recognition and object tracking is therefore carried out parallel to the image detection and to the evaluation and processes the detected data at least of the optoelectronic sensor or of the laser scanner. Known methods can be used for each scan in the object recognition and/or object tracking, with generally comparatively simple methods already being sufficient. Such a method can in particular take place independent of a complex object recognition and object tracking method in which the detected data are processed and, for example, a complex virtual object classification is carried out, with a tracking of segments in the depth image already being able to be sufficient.

The risk is also reduced by this correction that problems can occur in the fusion of image points of the depth image with image points of the video image. Furthermore, the subsequent processing of the image points is facilitated.

The positional coordinates of the image points are particularly preferably corrected in accordance with the movement data associated with them and in accordance with the difference between the detection time of the image points of the depth image and a reference point in time.

The movement data can again in particular be kinematic data, with the displacements used for the correction in particular being effected as above from the vectorial speeds and, optionally, from the accelerations of the virtual objects and from the time difference between the detection time of an image point of the depth image and the reference point in time.

The said corrections can be used alternatively or accumulatively.

If the demands on the accuracy of the correction are not too high, approximations for the detection time of the image points of the depth image can be used in these correction methods. It can in particular be assumed, when a laser scanner of the aforementioned type is used, that sequential image points were detected at constant time intervals. The time interval of sequential detections of image points can be determined from the time for a scan or from the scanning frequency and from the number of the image points taken in the process and a detection time relative to the first image point or, if negative times are also used, to any desired image point can be determined by means of this time interval and of the sequence of the image points. Although the reference point in time can generally be freely selected, it is preferred for it to be selected admittedly separately for each scan, but the same in each case, since then no differences of large numbers occur even after a plurality of scans and, furthermore, no displacement of the positions occurs by a variation of the reference point in time of sequential scans with a moving sensor, which could make a subsequent object recognition and object tracking more difficult.

It is particularly preferred in this process for the reference point in time to be the point in time of the detection of the video image. By this selection of the reference point in time, a displacement of image points which correspond relatively to the sensor or to objects moved relatively to one another is in particular corrected on the basis of the detection time displaced with respect to the video system, whereby the fusion of the depth image and of the video image leads to better results.

If the detection point in time of the video image can be synchronized with the scan of the field of view of the optoelectronic sensor, it is particularly preferred for the detection point in time, and thus the reference point in time to lie between the earliest time of a scan defined as the detection time of an image point of the depth image and the timewise last time of the scan defined as the detection time of an image point of the depth image. It is hereby ensured that errors which arise by the approximation in the kinematic description are kept as low as possible. A detection point in time of one of the image points of the scan can particularly advantageously be selected such that it obtains the time zero as the detection time within the scan.

In a further preferred embodiment of the method, a depth image and a video image are detected as a first step and their data are made available for the further method steps.

A further subject of the invention is a method for the recognition and tracking of objects in which image information o the monitored zone is provided using a method in accordance with any one of the preceding claims and an object recognition and object tracking is carried out on the basis of the provided image information.

A subject of the invention is moreover also a computer program with program code means to carry out one of the methods in accordance with the invention, when the program is carried out on a computer.

A subject of the invention is also a computer program product with program code means which are stored on a machine-readable data carrier in order to carry out one of the methods in accordance with the invention, when the computer program product is carried out on a computer.

A computer is understood here as any desired data processing apparatus with which the method can be carried out. This can in particular have digital signal processes and/or microprocessors with which the method can be carried out in full or in parts.

Finally, an apparatus is the subject of the invention for the provision of depth resolved images of a monitored zone comprising at least one optoelectronic sensor for the detection of the position of objects in at least one plane, in particular a laser scanner, a video system with at least one video camera and a data processing device connected to the optoelectronic sensor and to the video system which is designed to carry out one of the methods in accordance with the invention.

The video system preferably has a stereo camera. The video system is particularly preferably designed for the detection of depth resolved, three-dimensional images. The device required for the formation of the depth resolved video images from the images of the stereo camera can either be contained in the video system or be given by the data processing unit in which the corresponding operations are carried out.

To be able to fixedly pre-determine the position and alignment of the optoelectronic sensor and of the video system, it is preferred to integrate the optoelectronic sensor and the video system into one sensor such that their spatial arrangement relative to one another is already fixed on manufacture. Otherwise a calibration is necessary. An optical axis of an imaging apparatus particularly preferably lies close to a video camera of the video system at least in the region of the optoelectronic sensor, preferably in the detection plane. This arrangement permits a particularly simple determination of mutually associated image points of the depth image and of the video image. It is furthermore particularly preferred for the video system to have an arrangement of photo-detection elements, for the optoelectronic sensor to be a laser scanner and for the arrangement of photo-detection elements to be pivotable, in particular about a joint axis, synchronously with a radiation beam used for the scan of a field of view of the laser scanner and/or with at least one photo-detection element of the laser canner serving for the detection of radiation, since hereby the problems with respect to the synchronization of the detection of the video image and of the depth image are also reduced. The arrangement of photo-detection elements can in particular be a row, a column or an areal arrangement such as a matrix. A column or an areal arrangement are preferably also used for the detection of image points in a direction perpendicular to the detection plane.

### Embodiments of the invention will now be described by way of example with reference to the drawing. There are shown:

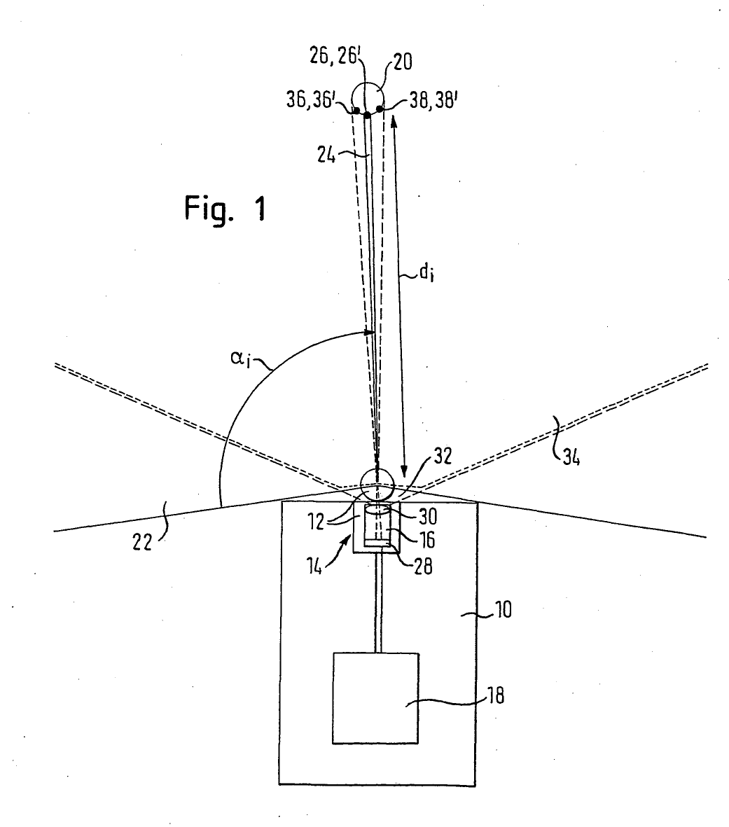

FIG. 1 a schematic plan view of a vehicle with a laser scanner, a video system with a monocular camera and a post located in front of the vehicle;

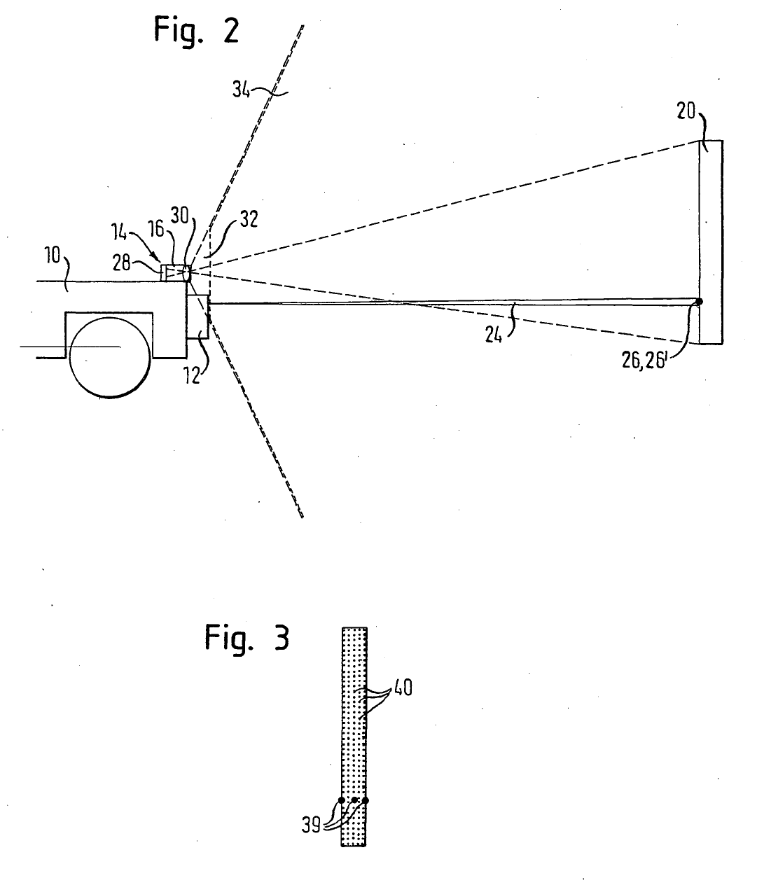

FIG. 2 a partly schematic side view of the vehicle and of the post in FIG. 1;

FIG. 3 a schematic part representation of a video image detected by the video system in FIG. 1;

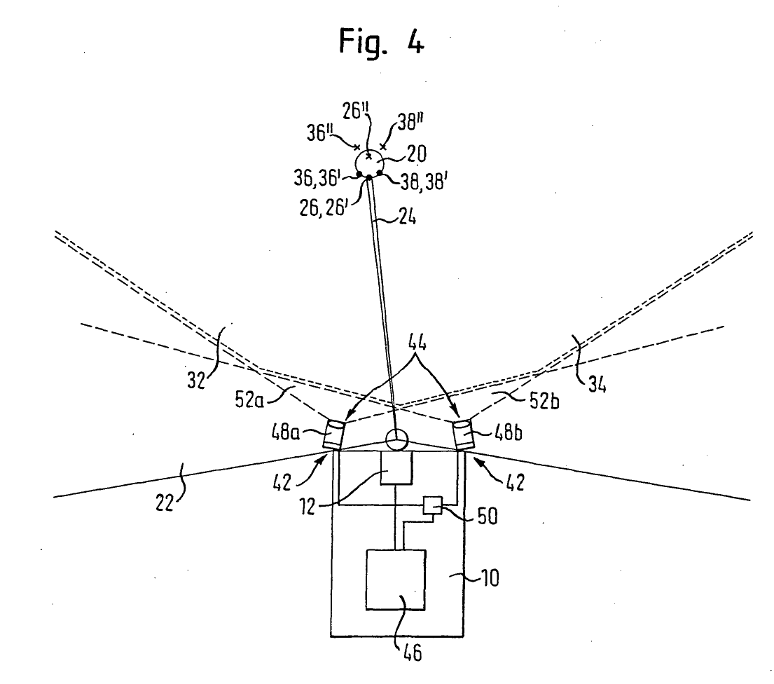

FIG. 4 a schematic plan view of a vehicle with a laser scanner, a video system with a stereo camera, and a post located in front of the vehicle; and

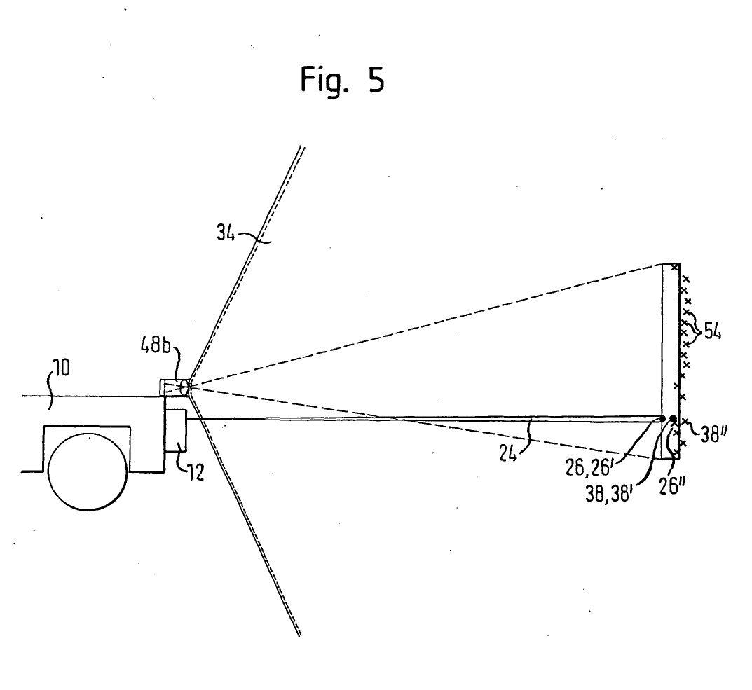

FIG. 5 a part, schematic side view of the vehicle and of the post in FIG. 4.

In FIGS. 1 and 2, a vehicle 10 carries a laser scanner 12 and a video system 14 with a monocular camera 16 at its front end for the monitoring of the zone in front of the vehicle. A data processing device 18 connected to the laser scanner 12 and to the video system 14 is furthermore located in the vehicle. A post 20 is located in front of the vehicle in the direction of travel.

The laser scanner 12 has a field of view 22, only shown partly in FIG. 1, which covers an angle of somewhat more than 180° due to the attachment position symmetrically to the longitudinal axis of the vehicle 10. The field of view 22 is only shown schematically in FIG. 1 and too small, in particular in the radial direction, for better illustration. The post 20 is located by way of example as the object to be detected in the field of view 22.

The laser scanner 12 scans its field of view 22 in a generally known manner with a pulsed laser radiation beam 24 rotating at a constant angular speed, with it being detected, likewise in a rotating manner, at constant time intervals Δt at times τᵢ in fixed angular ranges about a mean angle αᵢ whether the radiation beam 24 is reflected from a point 26 or from a region of an object such as the post 20. The index i runs in this process from 1 up to the number of angular regions in the field of view 22. Only one angular range of these angular regions is shown in FIG. 1 and is associated with the mean angle αᵢ. The angular range is shown exaggeratedly large for better illustration. The field of view 22 is, as can be recognized in FIG. 2, two-dimensional with the exception of the expansion of the radiation beam 24 and lies in one detection plane. The sensor spacing dᵢ of the object point 26 from the laser scanner 12 is determined with reference to the run time of the laser beam impulse. The laser scanner 12 therefore detects the angle αᵢ in the image point for the object point 26 of the post 20 and the spacing dᵢ detected at this angle as the coordinates, that is the position of the object point 26 in polar coordinates.

The set of the image points detected in a scan forms a depth image in the sense of the present application.

The laser scanner 12 scans its field of view 22 in each case in sequential scans such that a time sequence of scans and corresponding depth images arises.

The monocular video camera 16 of the video system 14 is a conventional black and white video camera with a CCD area sensor 28 and an imaging apparatus which is shown schematically as a simple lens 30 in FIGS. 1 and 2, but which actually consists of a lens system, and which images light incident from the field of view 32 of the video system onto the CCD area sensor 28. The CCD area sensor 28 has photo-detection elements arranged in a matrix. Signals of the photo-detection elements are read out, with video images being formed with image points which contain the positions of the photo-detection elements in the matrix or another code for the photo-detection elements and respectively an intensity value corresponding to the intensity of the light received by the corresponding photo-detection element. The video images are detected in this embodiment at the same rate at which depth images are detected by the laser scanner 12. Light transmitted by the post 20 is imaged by the lens 30 onto the CCD area sensor 28. This is indicated schematically by the short broken lines for the outlines of the post 30 in FIGS. 1 and 2.

From the spacing of the CCD area sensor 28 and the lens 30 as well as from the position and the imaging properties of the lens 30, for example its focal length, it can be calculated from the position of an object point, e.g. of the object point 26 on the post 20, on which of the photo-detection elements arranged as a matrix the object point will be imaged.

A monitored zone 34 is approximately represented schematically in FIGS. 1 and 2 by a dotted line and by that part of the field of view 32 of the video system whose projection onto the plane of the field of view 22 of the laser scanner lies inside the field of view 22. The post 20 is located inside this monitored zone 34.

The data processing device 18 is provided for the processing of the images of the laser scanner 12 and of the video system 14 and is connected to the laser scanner 12 and to the video system 14 for this purpose. The data processing device 18 has i.a. a digital signal processor programmed to carry out the method in accordance with the invention and a memory device connected to the digital signal processor. In another embodiment of the apparatus in accordance with the invention for the provision of image information, the data processing device can also have a conventional processor with which a computer program in accordance with the invention stored in the data processing device for the carrying out of the method in accordance with the invention is carried out.

In a first method for the provision of image information in accordance with a preferred first embodiment of the method in accordance with the invention according to the first alternative, a depth image is first detected by the laser scanner 12 and a video image is first detected by the video system 14.

It is assumed for the simpler representation that only the post 20 is located in the monitored zone 34. The depth image detected by the laser scanner 12 then has image points 26′, 26′ and 38′ which correspond to the object points 26, 36 and 38. These image points are marked in FIGS. 1 and 2 together with the corresponding object points. Only those image points 40 of the video image are shown from the video image in FIG. 3 which have substantially the same intensity values, since they correspond to the post 20.

The two images are then segmented. One segment of the depth image is formed from image points of which at least two have at most one predetermined maximum spacing. In the example, the image points 26′, 36′, 38′ form a segment.

The segments of the video image contain image points whose intensity values differ by less than a small pre-determined maximum value. In FIG. 3, the result of the segmentation is shown, with image points of the video image not being shown which do not belong to the shown segment which corresponds to the post 20. The segment therefore substantially has a rectangular shape which corresponds to that of the post 20.

If it is intended to find in an object recognition and object tracking method what kind of object the segment formed from the image points 26′, 36′ and 38′ of the depth image corresponds to, the information from the video image is used in addition. The total monitored zone 34 is pre-set as the fusion region in this process.

Those photo-detection elements or image points 39 of the video image which correspond to the object points-26, 36 and 38 and which are likewise shown in FIG. 3 are calculated from the positional coordinates of the image points 26′, 36′ and 38′ of the depth image while taking into account the relative position of the video system 14 to the detection plane of the laser scanner 12, the relative position to the laser scanner 12 and the imaging properties of the lens 30. Since the calculated image points 39 lie in the segment formed from image points 40, the segment formed from the image points 40 is associated with the image points 26′, 36′, 38′ corresponding to the object points 26, 26 and 38 or with the segment of the depth image formed therefrom. The height of the post 20 can then be calculated from the height of the segment with a given spacing while taking into account the imaging properties of the lens 30. This information can also be associated with the image points 26′, 36′ and 38′ of the depth image corresponding to the object points 26, 36 and 38. A conclusion can, for example, be drawn on the basis of this information that the segment of the depth image corresponds to a post or to a virtual object of the type post and not to a roadside post having a lower height. This information can likewise be associated with the image points 26′, 36′ and 38 of the depth image corresponding to the object points 26, 36 and 38.

These image points of the depth image can also be output or stored together with the associated information.

A second method in accordance with a further embodiment of the invention according to the first alternative differs from the first method in that it is not the information of the depth image which should be supplemented, but the information of the video image. The fusion region is therefore differently defined after the segmentation. In the example, it is calculated from the position of the segment formed from the image points 40 of the video image in the region or at the height of the detection plane of the laser scanner 12 in dependence on the imaging properties of the lens 30 which region in the detection plane of the laser scanner 12 the segment in the video image can correspond to. Since the spacing of the segment of the video system 14 formed from the image points 40 is initially not known, a whole fusion region results. An association to the segment in the video image is then determined for image points of the depth image lying in this fusion region as in the first method. The spacing of the segment in the video image from the laser scanner 12 can be determined using this. This information then represents a complementation of the video image data which can be taken into account on an image processing of the video image.

A further embodiment of the invention in accordance with the second alternative will now be described with reference to FIGS. 4 and 5. For objects which correspond to those in the preceding embodiments, the same reference numerals are used in the following and reference is made to the above embodiment with respect to the more precise description.

A vehicle 10 in FIG. 4 carries a laser scanner 12 and a video system 42 with a stereo camera 44 for the monitoring of the zone in front of the vehicle. A data processing device 46 connected to the laser scanner 12 and to the video system 42 is furthermore located in the vehicle 10. A post 20 is again located in front of the vehicle in the direction of travel.

Whereas the laser scanner 12 is designed as in the first embodiment and scans its field of view 22 in the same manner, in the present embodiment, the video system 42 with the stereo camera 44, which is designed for the detection of depth resolved images, is provided instead of a video system with a monocular video camera. The stereo camera is formed in this process by two monocular video cameras 48a and 48b attached to the front outer edges of the vehicle 10 and by an evaluation device 50 which is connected to the video cameras 48a and 48b and processes their signals into depth resolved, three-dimensional video images.

The monocular video cameras 48a and 48b are each designed like the video camera 16 of the first embodiment and are oriented in a fixedly predetermined geometry with respect to one another such that their fields of view 52a and 52b overlap. The overlapping region of the fields of view 52a and 52b forms the field of view 32 of the stereo camera 44 or of the video system 42.

The image points within the field of view 32 of the video system detected by the video cameras 48a and 48b are supplied to the evaluation device 50 which calculates a depth resolved image which contains image points with three-dimensional positional coordinates and intensity information from these image points while taking into account the position and alignment of the video cameras 48a and 48b.

The monitored zone 34 is, as in the first embodiment, given by the fields of view 22 and 32 of the laser scanner 12 or of the video system 42.

The laser scanner detects image points 26′,36′ and 38′ with high accuracy which correspond to the object points 26, 36 and 38 on the post 20.

The video system detects image points in three dimensions. The image points 26″, 36″ and 38″ shown in FIG. 4, detected by the video system 42 and corresponding to the object points 26, 36 and 38 have larger positional irregularities in the direction of the depth of the image due to the method used for the detection. This means that the spacings from the video system given by the positional coordinates of an image point are not very accurate.

In FIG. 5, further image points 54 of the depth resolved video image are shown which do not directly correspond to any image points in the depth image of the laser scanner 12, since they are not located in or close to the detection plane in which the object points 26, 36 and 37 lie. For reasons of clarity, further image points have been omitted.

For the processing of the images of the laser scanner 12 and of the video system 42, the data processing device 46 is provided which is connected for this purpose to the laser scanner 12 and to the video system 42. The data processing device 42 has i.a. a digital signal processor programmed to carry out the method in accordance with the invention according to the second alternative and a memory device connected to the digital signal processor. In another embodiment of the apparatus in accordance with the invention for the provision of image information, the data processing device can also have a conventional processor with which a computer program in accordance with the invention for the carrying out of an embodiment of the method of the method in accordance with the invention and described in the following is carried out.

As in the first embodiment, a depth image is detected and read in by the laser scanner 12 and a depth resolved, three-dimensional video image is detected and read in by the video system 42. Thereupon, the images are segmented, with the segmentation of the video image also being able to take place in the evaluation device 50 before or on the calculation of the depth resolved images. As in the first embodiment, the image points 26′, 36′ and 38′ of the depth image corresponding to the object points 26, 36 and 38 form a segment of the depth image.

In the segment of the video image which includes in the example the images points 26″, 36″, 38″ and 54 shown in FIGS. 4 and 5, as well as further image points not shown, the image points are determined which have a pre-determined maximum spacing from the detection plane in which the radiation beam 24 moves. If it is assumed that the depth resolved images have layers of image points in the direction perpendicular to the detection plane in accordance with the structure of the CCD area sensors of the video cameras 48a and 48b, the maximum spacing can, for example, be given by the spacing of the layers.

A part segment of the segment of the video image with the image points 26″, 36″ and 38″ is provided by this step which corresponds to the segment of the depth image.

By determining an optimum translation and/or an optimum rotation of the part segment, the position of the part segment is now matched to the substantially more precisely determined position of the depth segment. For this purpose, the sum of the quadratic distances of the positional coordinates of all image points of the segment of the depth image from the positional coordinates of all image points of the part segment transformed by a translation and/or rotation are minimized as a function of the translation and/or rotation.

For the correction of the positional coordinates of the total segment of the video image, the positional coordinates are transformed with the optimum transformation and/or rotation thus determined. The total segment of the video image is thereby aligned in the detection plane such that it has the optimum position in the detection plane with respect to the segment of the depth image determined by the laser scanner in that region in which it intersects the detection plane.

In another embodiment of the method, a suitable segment of the video image can also be determined starting from a segment of the depth image, with a precise three-dimensional depth resolved image again being provided after the matching.

Whereas, in the method in accordance with the invention according to the first alternative, a complementation of the image information of the depth image therefore takes place by the video image or vice versa, in the method in accordance with the invention according to the second alternative, a three-dimensional, depth resolved image with high accuracy of the depth information at least in the detection plane is provided by correction of a depth resolved, three dimensional video image.

### Reference Symbol List

10 vehicle

12 laser scanner

14 video system

16 monocular video camera

18 data processing device

20 post

22 field of view of the laser scanner

24 laser radiation beam

26, 26′, 26″ object point, image point

28 CCD area sensor

30 lens

32 field of view of the video system

34 monitored zone

36, 36′, 36″ object point, image point

38, 38′, 38″ object point, image point

39 calculated image points

40 image points

42 video system

44 stereo camera

46 data processing device

48a, b video cameras

50 evaluation device

52a, b fields of view

54 image points

1.-28. (Cancelled)

29. A method for the provision of image information concerning a monitored zone which lies in the field of view (22) of an optoelectronic sensor (12), in particular of a laser scanner, for the detection of the position of objects (20) in at least one detection plane and in the field of view (32) of a video system (14) with at least one video camera (16), in which
depth images are provided which are detected by the optoelectronic sensor (12) and which each contain image points (26′, 36′, 38′), which correspond to respective object points (26, 36, 38) on one or more detected objects (20) in the monitored zone, with positional coordinates of the corresponding object points (26, 36, 38), as well as video images of a region, said video images being detected by the video system (14) and containing the object points (26, 36, 38), and including the image points (26″, 36″, 38″, 54) with data detected by the video system;
at least one image point (26″, 36″, 38″, 54) is determined on the basis of the detected positional coordinates of at least one of the object points (26, 36, 38) corresponding to an object point (26, 36, 38) and detected by the video system (14); and
data corresponding to the image point (26″, 36″, 38″, 54) of the video image and the image point (26′, 36′, 38′) of the depth image and/or the positional coordinates of the object point (26, 36, 38) are associated with one another.

30. A method in accordance with claim 29, characterized in that the image point (26″, 36″, 38″, 54) of the video image corresponding to the object point (26, 36, 38) is determined in dependence on the imaging properties of the video system (14).

31. A method in accordance with claim 29, characterized in that is it determined on the basis of the positional coordinates of an object point (26, 36, 38) detected by the optoelectronic sensor (12) and on the basis of the position of the video system (14), whether the object point (26, 36, 38) is fully or partly masked in the video image detected by the video system (14).

32. A method in accordance with claim 29, characterized in that the determination of image points (26″, 36″, 38″, 54) of the video image corresponding to object points (26, 36, 38) and the association of corresponding data to image points (26′, 36′, 38′) of the depth image corresponding to the object points (26, 36, 38) takes place in a predetermined fusion region for object points (26, 36, 38).

33. A method in accordance with claim 29, characterized
in that the depth image and the video image are each segmented; and
in that at least one segment of the video image is associated with at least one segment in the depth image and contains image points (26″, 36″, 38″, 54) which correspond at least to some of the image points (26′, 36′, 38) of the segment of the depth image.

34. A method in accordance with claim 29, characterized
in that the depth image is segmented;
in that a pre-determined pattern is sought in a region of the video image which contains image points (26″, 36″, 38″, 54) which correspond to image points (26′, 36′, 38′) of at least one segment in the depth image; and
in that the result of the search is associated as data with the segment and/or with the image points (26′, 36′, 38′) forming the segment.

35. A method for the provision of image information concerning a monitored zone which lies in the field of view (22) of an optoelectronic sensor (12) for the detection of the position of objects (20) in at least one detection plane and in the field of view (32) of a video system (42) for the detection of depth resolved, three-dimensional video images with at least one video camera (44, 48a, 48b), in which
depth images are provided which are detected by the optoelectronic sensor (12) and which each contain image points (26′, 36′, 38′) corresponding to object points (26, 36, 38) on one or more detected objects (20) in the monitored zone as well as video images detected by the video system (42) of a region containing the object points (26, 36, 38), the video images containing image points (26″, 36″, 38″, 54) with positional coordinates of the object points (26, 36, 38);
image points (26″, 36″, 38″, 54) in the video image which are located close to or in the detection plane of the depth image are matched by a translation and/or rotation to corresponding image points (26′, 36′, 38′) of the depth image; and
the positional coordinates of these image points (26″, 36″, 38″, 54) of the video image are corrected in accordance with the determined translation and/or rotation.

36. A method in accordance with claim 35, characterized
in that respectively detected images are segmented;
in that at least one segment in the video image, which has image points (26″, 36″, 38″, 54) in or close to the detection plane of the depth image is matched to a corresponding segment in the depth image at least by a translation and/or rotation; and
in that the positional coordinates of these image points (26″, 36″, 38″, 54) of the segment of the video image are corrected in accordance with the translation and/or rotation.

37. A method in accordance with claim 35, characterized in that the matching is carried out jointly for all segments of the depth image.

38. A method in accordance with claim 35, characterized in that the matching is only carried out for segments in a pre-determined fusion region.

39. A method in accordance with claim 29, characterized in that the provided image information contains at least the positional coordinates of detected object points (26, 36, 38) and is used as the depth resolved image.

40. A method in accordance with claim 29, characterized in that the fusion region is determined on the basis of a pre-determined section of the video image and of the imaging properties of the video system (14, 42).

41. A method in accordance with claim 29, characterized
in that an object recognition and object tracking are carried out on the basis of the data of one of the depth resolved images or of the provided image information; and
in that the fusion region is determined with reference to data of the object recognition and object tracking.

42. A method in accordance with claim 29, characterized in that the fusion region is determined with reference to data on the presumed position of objects (20) or of specific regions on the objects (20).

43. A method in accordance with claim 29, characterized in that the fusion region is determined with reference to data from a digital road map in conjunction with a GPS receiver.

44. A method in accordance with claim 29, characterized in that a plurality of depth images of one or more optoelectronic sensors (12) are used.

45. A method in accordance with claim 44, characterized in that the matching is carried out simultaneously for segments in at least two or more depth images.

46. A method in accordance with claim 29, characterized
in that a depth image is used which was obtained in that, on a scan of the field of view (22) of the optoelectronic sensor (12), the image points (26′, 36′, 38′) were detected sequentially; and
in that the positional coordinates of the image points (26′, 36′, 38′) of the depth image are corrected prior to the determination of the image points (26″, 36″, 38″, 54) in the video image or to the segment formation in each case in accordance with the actual movement of the optoelectronic sensor (12), or a movement approximated thereto, and in accordance with the difference between the points in time of detection of the respective image points (26′, 36′, 38′) of the depth image and a reference point in time.

47. A method in accordance with claim 29, characterized
in that depth images are used which were obtained in that, on a scan of the field of view (22) of the optoelectronic sensor (12), the image points (26′, 36′, 38) were detected sequentially;
in that a sequence of depth images is detected and an object recognition and/or object tracking is/are carried out on the basis of the image points (26′, 36′, 38′) of the images of the monitored zone, with image points (26′, 36′, 38′) being associated with each recognized object and movement data calculated with respect to the object tracking being associated with each of these image points (26′, 36′, 38′); and
in that the positional coordinates of the image points (26′, 36′, 38) of the depth image are corrected prior to the determination of the image points (26″, 36″, 38″, 54) in the video image or prior to the matching of the positional coordinates using the results of the object recognition and/or object tracking.

48. A method in accordance with claim 47, characterized in that, in the correction, the positional coordinates of the image points (26′, 36′, 38′) are corrected in accordance with the movement data associated therewith and in accordance with the difference between the detection time of the image points (26′, 36′, 38′) and a reference point in time.

49. A method in accordance with claim 46, characterized in that the reference point in time is the point in time of the detection of the video image.

50. A method in accordance with claim 47, characterized in that the reference point in time is the point in time of the detection of the video image.

51. A method for the recognition and tracking of objects, in which information is provided concerning a monitored zone using a method in accordance with claim 29; and
an object recognition and an object tracking are carried out on the basis of the provided image information.

52. A method in accordance with claim 35, characterized in that the provided image information contains at least the positional coordinates of detected object points (26, 36, 38) and is used as the depth resolved image.

53. A method in accordance with claim 35, characterized in that the fusion region is determined on the basis of a pre-determined section of the video image and of the imaging properties of the video system (14,42).

54. A method in accordance with claim 35, characterized
in that an object recognition and object tracking are carried out on the basis of the data of one of the depth resolved images or of the provided image information; and
in that the fusion region is determined with reference to data of the object recognition and object tracking.

55. A method in accordance with claim 35, characterized in that the fusion region is determined with reference to data on the presumed position of objects (20) or of specific regions on the objects (20).

56. A method in accordance with claim 35, characterized in that the fusion region is determined with reference to data from a digital road map in conjunction with a GPS receiver.

57. A method in accordance with claim 35, characterized in that a plurality of depth images of one or more optoelectronic sensors (12) are used.

58. A method in accordance with claim 57, characterized in that the matching is carried out simultaneously for segments in at least two or more depth images.

59. A method in accordance with claim 35, characterized
in that a depth image is used which was obtained in that, on a scan of the field of view (22) of the optoelectronic sensor (12), the image points (26′, 36′, 38′) were detected sequentially; and
in that the positional coordinates of the image points (26′, 36′, 38′) of the depth image are corrected prior to the determination of the image points (26″, 36″, 38″, 54) in the video image or to the segment formation in each case in accordance with the actual movement of the optoelectronic sensor (12), or a movement approximated thereto, and in accordance with the difference between the points in time of detection of the respective image points (26′, 36′, 38′) of the depth image and a reference point in time.

60. A method in accordance with claim 35, characterized
in that depth images are used which were obtained in that, on a scan of the field of view (22) of the optoelectronic sensor (12), the image points (26′, 36′, 38) were detected sequentially;
in that a sequence of depth images is detected and an object recognition and/or object tracking is/are carried out on the basis of the image points (26′, 36′, 38′) of the images of the monitored zone, with image points (26′, 36′, 38′) being associated with each recognized object and movement data calculated with respect to the object tracking being associated with each of these image points (26′, 36′, 38′); and
in that the positional coordinates of the image points (26′, 36′, 38) of the depth image are corrected prior to the determination of the image points (26″, 36″, 38″, 54) in the video image or prior to the matching of the positional coordinates using the results of the object recognition and/or object tracking.

61. A method in accordance with claim 60, characterized in that, in the correction, the positional coordinates of the image points (26′, 36′, 38′) are corrected in accordance with the movement data associated therewith and in accordance with the difference between the detection time of the image points (26′, 36′, 38′) and a reference point in time.

62. A method in accordance with claim 59, characterized in that the reference point in time is the point in time of the detection of the video image.

63. A method in accordance with claim 60, characterized in that the reference point in time is the point in time of the detection of the video image.

64. A method for the recognition and tracking of objects, in which information is provided concerning a monitored zone using a method in accordance with claim 35; and
an object recognition and an object tracking are carried out on the basis of the provided image information.

65. A computer program with program code means to carry out a method in accordance with claim 29, when the program is carried out on a computer.

66. A computer program product with program code means which are stored on a machine-legible data carrier to carry out a method in accordance with claim 29, when the computer program product is carried out on a computer.

67. An apparatus for the provision of depth resolved images of a monitored zone, with at least one optoelectronic sensor (12) for the detection laser scanner, with a video system (14, 42) with at least one video camera (16, 44, 48a, 48b) and with a data processing device (18, 46) which is connected to the optoelectronic sensor (12) and to the video system (14, 42) and is designed to carry out a method in accordance with claim 29.

68. An apparatus in accordance with claim 67, characterized in that the video system (14, 42) has a stereo camera (44, 48a, 48b).

69. An apparatus in accordance with claim 67, characterized in that the video system and the optoelectronic sensor are integrated to form a sensor.

70. An apparatus in accordance with claim 67, characterized
in that the video system has an arrangement of photo-detection elements;
in that the optoelectronic sensor is a laser scanner; and
in that the arrangement of photo-detection elements is pivotable, in particular about a common axis, synchronously with a radiation beam used for the scan of a field of view of the laser scanner and/or with at least one photo-detection element of the laser scanner serving for the detection of radiation.

71. A computer program with program code means to carry out a method in accordance with claim 35, when the program is carried out on a computer.

72. A computer program product with program code means which are stored on a machine-legible data carrier to carry out a method in accordance with claim 35, when the computer program product is carried out on a computer.

73. An apparatus for the provision of depth resolved images of a monitored zone, with at least one optoelectronic sensor (12) for the detection of the position of objects (20) in at least one detection plane, in particular a laser scanner, with a video system (14, 42) with at least one video camera (16, 44, 48a, 48b) and with a data processing device (18, 46) which is connected to the optoelectronic sensor (12) and to the video system (14, 42) and is designed to carry out a method in accordance with claim 35.

74. An apparatus in accordance with claim 73, characterized in that the video system (14, 42) has a stereo camera (44, 48a, 48b).

75. An apparatus in accordance with claim 73, characterized in that the video system and the optoelectronic sensor are integrated to form a sensor.

76. An apparatus in accordance with claim 73, characterized in that the video system has an arrangement of photo-detection elements; in that the optoelectronic sensor is a laser scanner; and in that the arrangement of photo-detection elements is pivotable, in particular about a common axis, synchronously with a radiation beam used for the scan of a field of view of the laser scanner and/or with at least one photo-detection element of the laser scanner serving for the detection of radiation.
